(19) United States
(12) Patent Application Publication
(10) Pub. No.: US 2004/0167717 A1
(43) Pub. Date: Aug. 26, 2004

(54) Sensing apparatus for vehicles

(76) Inventors: Alastair James Buchanan, Sutton Coldfield (GB); Andrew Oghenovo Oyaide, Birmingham (GB); Tuan Hoe Edwin Foo, Singapore (SG)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/713,789

(22) Filed: Nov. 14, 2003

Related U.S. Application Data
(63) Continuation of application No. PCT/GB02/02324, filed on May 17, 2002.

(30) Foreign Application Priority Data
May 17, 2001 (GB) 0111979.1

(51) Int. Cl. G08G 1/16

(52) U.S. Cl. 701/301; 701/96; 340/903; 340/436

(57) ABSTRACT

A target object position sensing apparatus for a host vehicle, comprises a lane detection apparatus provided on the host vehicle which includes an image acquisition means adapted to capture an image of at least a part of the road ahead of the host vehicle, a vehicle path estimation means adapted to estimate a projected path for the host vehicle, and a target vehicle detection apparatus which is adapted to identify the position of any target objects located on the road ahead of the host vehicle, the position including data representing the distance of the target vehicle from the host vehicle. A first data processing means determines a target lane in which the host vehicle will be located when it has travelled along the projected path by the distance to the target object and a second processing means compares the position of the target vehicle determined by the target vehicle detection means with the position of the target lane to provide a processed estimate of the actual position of the target object.

This invention relates to improvements in sensing apparatus for vehicles. It in particular but not exclusively relates to a target object position sensing apparatus for a host vehicle that is adapted to estimate the location of a target vehicle or other target object from a range of vehicles or other objects relative to a projected path of a host vehicle. In a further aspect the invention provides an adaptive cruise control system which incorporates such apparatus.

In recent years the introduction of improved sensors and increases in processing power have led to considerable improvements in automotive control systems. Improvements in vehicle safety have driven these developments which are approaching commercial acceptance. One example of the latest advances is the provision of adaptive cruise control for vehicles, often referred to as ACC.

Current ACC systems are structured around position sensors which detect the presence of other vehicles and obstacles which are positioned on the road ahead of the host vehicle. The detection is typically performed using one or more radar or lidar based sensors mounted at the front of the host vehicle. The sensors identify the location of detected objects relative to the host vehicle and feed information to a processor. The processor determines whether or not the target object lies in a projected path for the host vehicle.

In an ACC system, the system may search for a target object corresponding to a vehicle travelling in front of the host vehicle along the road and automatically following the identified vehicle. This permits a convoy of vehicles to safely follow one another along a road with little or no intervention from the driver. In this case it is important that only targets that are in the same lane as the host vehicle are followed for obvious reasons. This is particularly relevant on a motorway which has many parallel lanes where it is envisaged that such as system will be of most benefit.

There are several problems inherent in the design of a reliable ACC system.

Where a host vehicle is travelling along a straight road then implementation is trivial. Only targets directly ahead of the vehicle need be tracked. If the road is curved the problem is far from trivial.

In the first generation of ACC systems the identification of the lane in which a preceding target vehicle is travelling is achieved using a combination of radar to detect the position of target objects with yaw sensors located on the host vehicle to determine the trajectory or projected path of the host vehicle. The output of the yaw sensor enables the radius of the projected path of the vehicle to be determined, i.e. the radius along which the host vehicle is travelling at the instant at which measurements are made. The curvature of the path is then projected in front of the vehicle and targets are tracked which lie on the projected path.

However, the performance of these systems is limited as the projection of the current vehicle's instantaneous position only holds true when the host vehicle and the impeding vehicle are following the same radius path. Also, the information that can be obtained from a yaw sensor is typically of low quality which results in poor reliability for the system. This can cause errors in the projected path.

An object of the present invention is to ameliorate some of the problems of the prior art.

In accordance with a first aspect the invention provides a target object position sensing apparatus for a host vehicle, the apparatus comprising:

a lane detection apparatus provided on the host vehicle which includes an image acquisition means adapted to capture an image of at least a part of the road ahead of the host vehicle;

a vehicle path estimation means adapted to estimate a projected path for the host vehicle;

a target vehicle detection apparatus located on the host vehicle which is adapted to identify the position of any target objects located on the road ahead of the host vehicle, the position including data representing the distance of the target vehicle from the host vehicle;

first data processing means adapted to determine a target lane in which the host vehicle will be located when it has travelled along the projected path by the distance to the target object;

and second processing means adapted to compare the position of the target vehicle determined by the target vehicle detection means with the position of the target lane to provide a processed estimate of the actual position of the target object.

Thus, the invention provides for the combination, or fusion, of information from lane detection apparatus and vehicle position detection apparatus to enable the location of an impeding vehicle to be reliably determined.

The use of lane detection eliminates the need for projected path information provided from a yaw sensor by using real identified lane information to estimate the position of a target or impeding vehicle and the host vehicle.

The processed estimate may comprise an indicator of whether or not the target vehicle is in the same lane as the host vehicle is projected to be in when at the point of the target vehicle. The image acquisition means of the lane detection apparatus may comprise a video camera which is adapted to produce a, or at least one, two-dimensional image of an area of the road in front of the host vehicle. Many images may be captured in sequence over time as the vehicle travels along a road.

The captured image may be passed to an image processing unit. This may filter the or each image to identify artefacts in the image corresponding to one or more of: the right hand edge of a road, the left hand edge of the road, lane markings defining lanes in the road, the radius of curvature of the lane and or the road, and optionally the heading angle of the host vehicle relative to the road/lane. These detected artefacts output from the image processing unit may be passed to the first data processor to determine the path of the host vehicle. The output data may be continuously updated whenever a new image is captured over time.

The image processing unit may be adapted to process the identified road information using one or more image processing algorithms.

In a first stage the image processing unit may be adapted to apply an edge detection algorithm to detect lines or curves that correspond to lane boundaries. The image processing unit may further include a transformation algorithm, such as an inverse perspective algorithm, to convert the edge detected points of the lane boundaries from the image plane to the real world plane.

The image processing unit may also include a tracking algorithm which may employ a recursive least squares technique to identify the path of lanes in the or each processed image.

The output of the image processing unit comprises data representing the lane topography which is passed to the first data processing means. It may also include information including the position of the host vehicle relative to the identified lanes and its heading.

The first data processing means may determine the target lane in several possible ways. Before this can be achieved, however, the vehicle path estimation means must determine a projected path for the vehicle.

The vehicle path estimation means may determine the curvature of a path that the vehicle is expected to follow in several ways. For example, the lane information may be used to determine which lane the host vehicle is presently travelling in and it may be assumed that the host vehicle will remain in that lane. Thus, the projected path may correspond to the path of the lane. It will be assumed to have the same curvature as that lane.

To accommodate the situation where the host vehicle may change lane before it reaches the target vehicle the vehicle path estimation means may estimate the path by projecting a path based upon the heading of the host vehicle. This may coincide with the path of a lane but is actually independent of the lane orientation.

In another arrangement, if a, or the, processed image indicates that the host vehicle is towards the left hand side of a lane and heading left relative to the road the path estimation means may predict that the path of the host vehicle will continue for a short while to stay in that lane but will shortly change to a different lane to the left. A similar prediction may be made for a change to the right.

In a further alternative or in addition the vehicle path estimation means may include a yaw sensor which determines the rate of yaw of the host vehicle to provide a measure of the radius of curvature of the path the host vehicle is following. This can be combined with heading of the vehicle obtained from the captured image.

The first data processing means may then determine which lane the host vehicle will occupy when it has travelled the distance to the target object by projecting the path estimated by the path estimation means with the lane boundary information at that distance. The host vehicle may then be placed in the appropriate lane by fitting the projected path to the observed lane boundaries at that point.

The target vehicle detection apparatus may comprise an emitter which emits a signal outward in front of the vehicle and a receiver which is adapted to receive a portion of the emitted signal reflected from objects in front of the vehicle, and a target processing means which is adapted to determine the distance between the host vehicle and the object.

The emitter and the receiver preferably emit and receive radar signals or lidar signals. Of course, other range finding technology may be employed in this application if preferred. The distance between the host vehicle and a target vehicle or object may be determined by the processing means based upon the time of flight of a signal from emission of the signal to receipt of a reflected portion of the signal.

It will be appreciated that the provision of apparatus for identifying the location of a target object can be used as part of many types of vehicle control systems.

Thus, in accordance with a second aspect the invention provides an adaptive cruise control system for a host vehicle comprising:

sensing apparatus according to the first aspect of the invention adapted to estimate the position of a target vehicle or object on a highway; and

signal generating means adapted to generate a steering bias signal which when applied to a steering system of the host vehicle assists in controlling the direction of the vehicle so as to cause the host vehicle to track the target vehicle.

The signal generating means may further generate at least one vehicle speed control signal which when applied to a brake system or a throttle control system of the vehicle causes the vehicle to maintain a predetermined distance behind the impending vehicle.

The vehicle steering and or braking and or throttle signals may be generated in response to the estimate of the target position determined by the sensing apparatus. The control signals may only be generated for target vehicles that occupy the projected path of the host vehicle, i.e. are in the same lane.

There will now be described by way of example only one embodiment of the present invention with reference to the accompanying drawings of which:

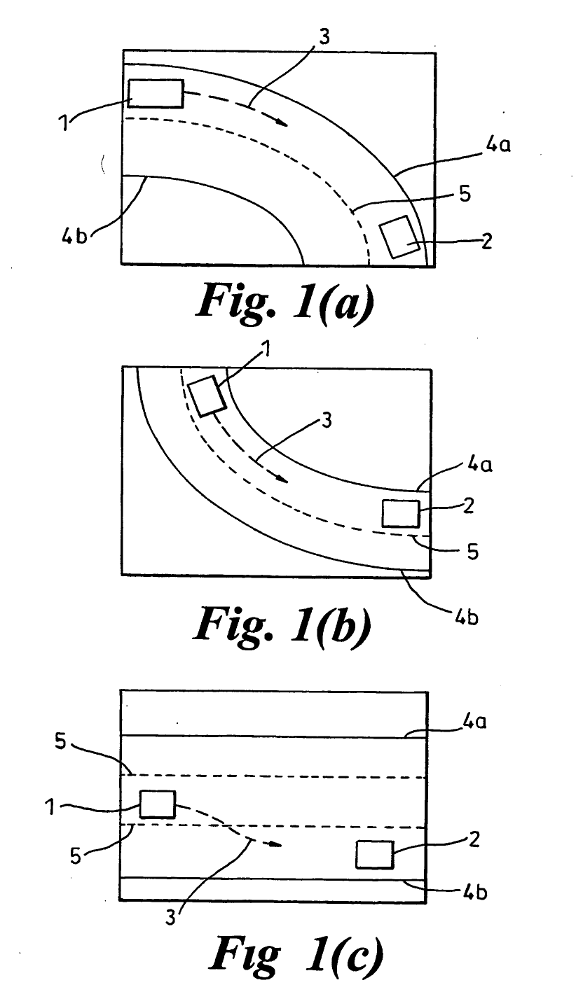

FIG. 1 is an illustration of the relationship between a target vehicle and a host vehicle when the host vehicle is travelling (a) into a bend, (b) out of a bend and (c) when changing lanes;

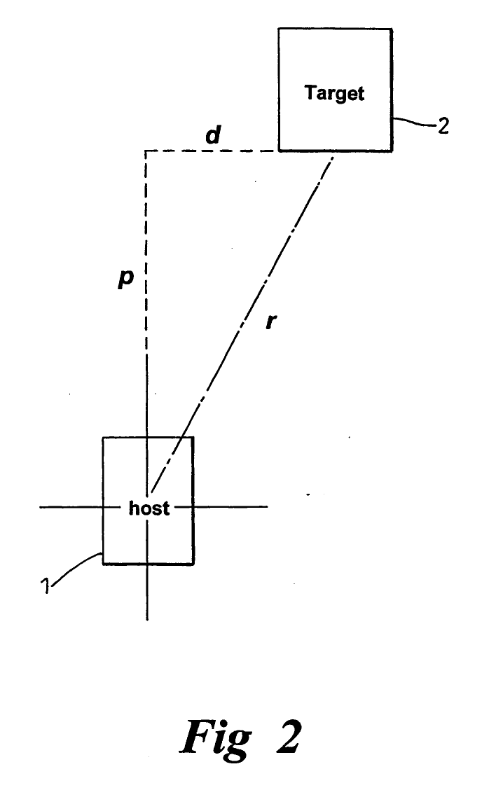

FIG. 2 is a simple geometrical illustration of the relationship between the host vehicle and the target vehicle;

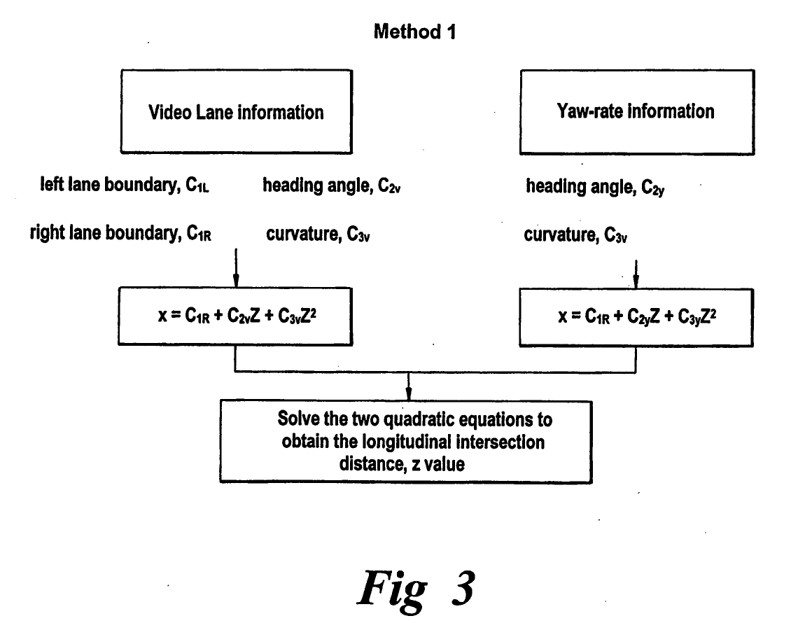

FIG. 3 is a flow chart illustrating a first method of estimating the target lane position for the host vehicle;

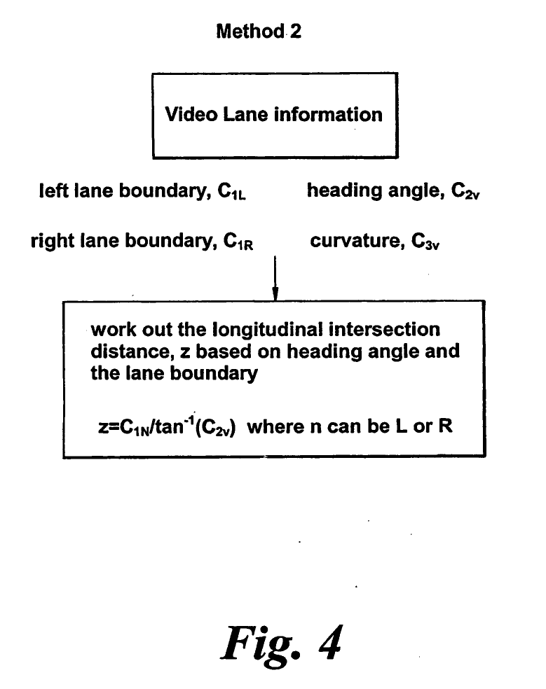

FIG. 4 is a flow chart illustrating a second method of estimating the target lane position for the host vehicle;

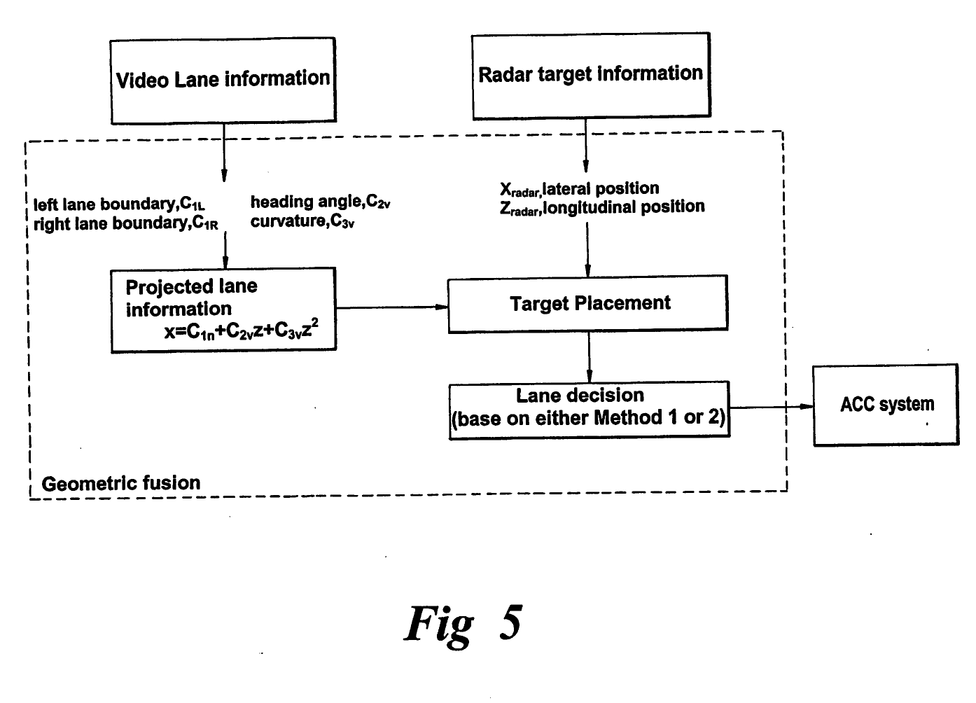

FIG. 5 is a flow diagram providing an overview of the strategy implemented by the sensor apparatus of the present invention when estimating target vehicle location; and

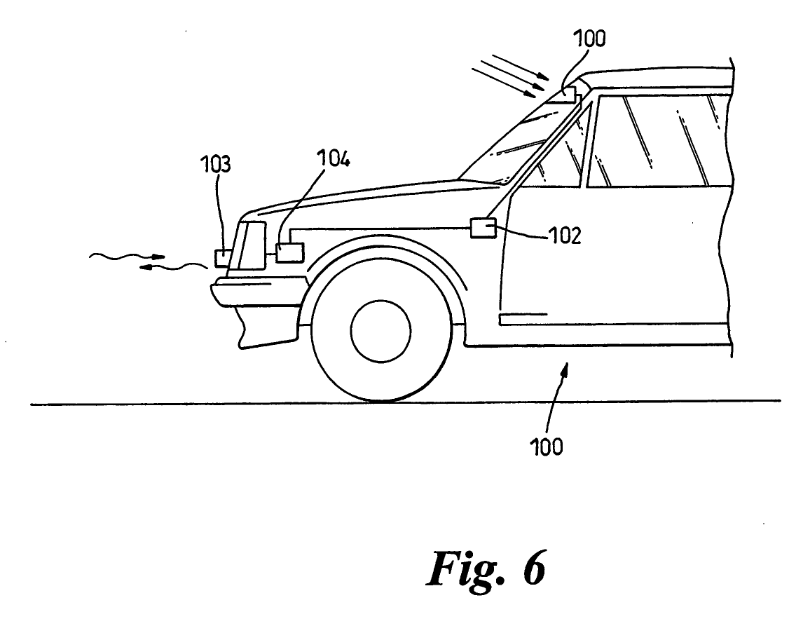

FIG. 6 is an overview of the components of the system for the present invention.

As described hereinbefore the prior art approach to curvature prediction for a vehicles projected path has employed yaw rate measurements together with measurements of a vehicles speed.

This approach is adequate for the majority of road situations in which ACC is expected to operate. However, when the complexity of the road environment increases the result can be that incorrect “targets” are selected. By target we mean either an impending vehicle or an object such in the path of the host vehicle. These complex situations are typically encountered at the entry and exit of bends and during lane change manoeuvres as illustrated in FIGS. 1(a), 1(b) and 1(c) respectively of the accompanying drawings. In each drawing, the host vehicle is indicated by the numeral 1 and the target vehicle by the numeral 2. The dotted-dashed line 3 illustrates the projected path of the host vehicle, with the solid lines 4a,4b indicating the road edges and the dashed line 5 a lane boundary.

The system of the present invention improves on the prior art by providing for an image capture apparatus to detect the location of lane boundaries relative to the host vehicle. This can be used to determine information relating to the position of the host vehicle relative to the lane boundaries, the lane width and the heading of the vehicle relative to the lane in order to estimate a projected trajectory for the vehicle.

The apparatus required to implement the system is illustrated in FIG. 6 of the accompanying drawings. In its simplest form comprises a video camera 100 mounted to the front of a host vehicle 101 and an image processing board. The image processing board captures images from the camera in real time. A radar or lidar type sensor 103 is also mounted to the front of the vehicle 101 which provides object identification and also allows the distance of the detected objects from the host vehicle 101 to be determined together with the bearing of the object relative to the host vehicle. The output of the radar sensor 103 and the image processing board 102 is passed to a data processor 104 located within the vehicle which combines or fuses the image and object detection data as illustrated in the general flow diagram of FIG. 5 of the accompanying drawings.

The data processor performs both low level imaging processing and also higher level processing functions.

The data processor implements software algorithms employed in the lane detection system comprising the following:

A feature point detection routine to extract the lane markings from the captured image scene, preferably using an edge detection algorithm to identify lines and curves in the scene

A transformation algorithm that converts the edge detected points in the image from the image plane into the real world plane. The transformation is based around an inverse perspective transform that can be expressed (equation 1 below) as:

$$x = \frac{h X}{H - Y} and z = \frac{f h}{H - Y} \qquad ( 1 )$$

where X and Y are the image co-ordinates referenced from the centre of the bottom line of the captured image, H is the horizon, f is the focal length of the capture camera, h is the height of the camera above the ground, and x, z are the real world co-ordinates. The z co-ordinate represents the distance in the real world ahead of the host vehicle.

A tracking algorithm, which uses an adapted recursive least-squares technique in the estimation of the lane model parameters. This lane model has a second order relationship and can be described (equation 2 below) as:

x=c₁+c₂z+c₃z² (2)

where c₁ corresponds to the left/right lane marking offset, c₂ is the lane heading angle and c₃ is twice the lane curvature.

The output from the data processor following application of these algorithms (or other processing) to the captured image is transmitted over a data bus to a secondary data processing unit. This data fully describes the road on which the host vehicle is travelling and includes one or more of the following parameters

Road Curvature

This provides a preview of the road ahead, and is important for correct target placement during bend-in and bend-out situations.

Lane Offsets

The left and right offsets allow the calculation of the lane width and the vehicles lane position. The lane width may vary considerably from lane to lane (for example some US highways and road works). The vehicles position in the lane can be used to determine whether or not the driver intends to change lane.

Heading Angle

This can be used in conjunction with the vehicles lane position for predicting the drivers lane manoeuvre intentions.

Confidence Level

A measure of the confidence of the lane parameter estimation is also calculated and transmitted via the bus to the secondary processor. This calculation is based on the variance associated with the parameter estimation. The confidence level is particularly important in the event that lane markings have deteriorated or the road layout is very complicated. If a low confidence level is indicated the system may switch to an alternative strategy for target selection.

The secondary processor fuses together the data describing the road layout with data obtained from the vehicle identification sensor(s) in real time. This enables it to be integrated within ACC or other driver assistance systems.

The fusion of the two types of data can best be understood with reference to FIG. 2 of the accompanying drawings. This shows a a typical situation with a host vehicle negotiating a curve. Using the small angle approximation, the obstacle information can be combined with the lane curvature information to obtain a better target placement.

The information required to do this is the range (r) and the lateral distance from the host to a detected object. Using these parameters the perpendicular distance, p(m) at the centre of the vehicle can be calculated (according to equation 3) as:

p=\sqrt{(r²−d²)}

The left and the right lane markings of the target, xₗ and xᵣ can be calculated by applying equation 2 for the right and the left hand lane markings respectively using the distance determined using equation 3.

Using the values of xᵣ and xₗ, the target vehicle position offset from the predicted host vehicle centre (using the projected path) is calculated with the lateral distance and the left and right target lane markings x_{L} and x_{R}. The targets can then be placed in the correct lane.

This technique described in the preceding paragraphs deals with the case where the host vehicle is assumed to be staying in the same lane along its projected path. If the projected path of the vehicle takes it into a different lane then one or both of two possible methods may be applied.

In the first method (shown in the flow diagram of FIG. 3 of the accompanying drawings) additional information is obtained from a yaw sensor which measures the rate of yaw of the vehicle. This is used to determine a radius of curvature for the vehicle. This is projected to the target distance and the point of intersection of this path with the projected lane markings at the target distance is used to determine the lane in which the host vehicle will be located. This selected lane is then used as in the preceding paragraphs in comparison with the radar data to select the correct lane for the target vehicle.

In a second method, illustrated in the flow chart of FIG. 4 of the accompanying drawings the heading angle of the vehicle relative to the lane boundaries when the image is captured may be used. Again, this can be projected onto the lane boundaries at the distance of the target to determine the lane in which the host vehicle will be located.

With the first method a high quality yaw signal is needed for acceptable accuracy. In general, an affordable yaw sensor can not provide this as it suffers from noise and drift problems. Furthermore it is also sensitive to disturbance induced by the driver, reacts slowly to a bend and recovers slowly after coming out of a bend.

Conversely, the video information is less affected by disturbance from the driver and so is preferred in some applications to apply the second method in preference to the first. Nevertheless, both methods fall within the scope of the present invention.

In summary it will be appreciated that the present invention provides for an enhanced estimation of the position of a target object in the path of a host vehicle by combining actual target position information with lane marking data obtained from a video camera. The video information allows the lane in which the host vehicle is expected to be located when it reaches the target to be estimated comparing the markings for this lane with the measured target position the actual lane in which the target is located can be estimated.

It will also be understood that the identification of the location of the target device permits the apparatus to be incorporated into a range of drive assistance systems such as adaptive cruise control.

1. A target object position sensing apparatus for a host vehicle, the apparatus comprising:
a lane detection apparatus provided on the host vehicle which includes an image acquisition means adapted to capture an image of at least a part of the road ahead of the host vehicle;
a vehicle path estimation means adapted to estimate a projected path for the host vehicle;
a target vehicle detection apparatus located on the host vehicle which is adapted to identify the position of any target objects located on the road ahead of the host vehicle, the position including data representing the distance of the target vehicle from the host vehicle;
first data processing means adapted to determine a target lane in which the host vehicle will be located when it has travelled along the projected path by the distance to the target object;
and second processing means adapted to compare the position of the target vehicle determined by the target vehicle detection means with the position of the target lane to provide a processed estimate of the actual position of the target object.

2. The apparatus of claim 1 in which the processed estimate comprises an indicator of whether or not the target vehicle is in the same lane as the host vehicle is projected to be in when at the point of the target vehicle.

3. The apparatus of claim 1 or claim 2, in which the image acquisition means of the lane detection apparatus comprises a video camera which is adapted to produce at least one two-dimensional image of an area of the road in front of the host vehicle.

4. The apparatus of any preceding claim in which the or each captured image is passed to an image processing unit.

5. The apparatus of claim 4 in which the image processing unit is adapted to filter the or each image to identify artefacts in the image corresponding to at least one of the right hand edge of a road, the left hand edge of the road, lane markings defining lanes in the road, the radius of curvature of the lanes and the road, and the heading angles of the host vehicle relative to the road and lanes.

6. The apparatus of claim 4 or claim 5 in which the image processing unit is further adapted to perform a transformation algorithm, to convert the edge detected pointing of the lane boundaries from the image plane to the real world plane.

7. The apparatus of any one of claims 4 to 6 in which the image processing unit is adapted to apply an edge detection algorithm to the or each image to detect lines or curves that correspond to lane boundaries.

8. The apparatus of claim 7 in which the image processing unit is adapted to perform a tracking algorithm which employs a recursive least squares technique to identify the path of lanes in the or each image.

9. The apparatus of any one of claims 7 or 8 in which the output of the image processing unit comprises data representing lane topography which is passed to the first data processing means.

10. The apparatus of claim 9 in which the output of the image processing unit also includes information including the position of the host vehicle relative to the identified lanes and its heading.

11. The apparatus of any one of claims 7 to 10 in which the first data processing means is adapted to determine which lane the host vehicle will occupy when it has travelled the distance to a target object by projecting the path estimated by the vehicle path estimation means with lane boundary information at that distance.

12. The apparatus of any one of claims 7 to 11 in which the vehicle path estimation means is adapted to use lane information to determine which lane the host vehicle is presently travelling in.

13. The apparatus of any previous claim in which the vehicle path estimation means may estimate the path by projecting a path based upon the heading of the host vehicle.

14. The apparatus of claim 12 in which the projected path corresponds to the path of the lane.

15. The apparatus of claim 12 in which the vehicle path estimation means is adapted to predict that, if the processed image indicates that the host vehicle is towards a given side of a lane and heading towards that given side relative to the road the path estimation means may predict that the path of the host vehicle will continue for a short while to stay in that lane but will shortly change to a different lane to the given side.

16. The apparatus of any preceding claim in which the vehicle path estimation means includes a yaw sensor which is adapted to determine the rate of yaw of the host vehicle in order to provide a measure of the radius of curvature of the path a vehicle is following.

17. The apparatus of any preceding claim in which the target vehicle detection apparatus comprises an emitter which emits a signal outward in front of the host vehicle and a receiver which is adapted to receive a portion of the emitted signal reflected from objects in front of the vehicle, and a target processing means which is adapted to determine the distance between the host vehicle and the object.

18. The apparatus of claim 17 in which the emitter and the receiver emit and receive one of radar signals and lidar signals.

19. The apparatus of claim 17 or claim 18 in which the distance between the host vehicle and a target vehicle or object is determined by the target processing means based upon the time of flight of a signal from emission of the signal to receipt of a reflected portion of the signal.

20. An adaptive cruise control system for a host vehicle comprising:
sensing apparatus according to any preceding claim and signal generating means adapted to generate a steering bias signal which when applied to a steering system of the vehicle assists in controlling the direction of the vehicle so as to cause the host vehicle to track the target vehicle.

21. The control system of claim 20 in which the signal generating means generates at least one vehicle speed control signal which when applied to a brake system or a throttle control system of the vehicle cause the vehicle to maintain a predetermined distance behind a target vehicle.

22. The control system of claim 20 or claim 21 in which at least one of the signals is generated in response to the estimate of the target position determined by the sensing apparatus.

23. The control system of any one of claims 20 to 22 in which the control signals are only be generated for target vehicles that occupy the projected path of the host vehicle.
